(19) United States
(12) Patent Application Publication
(10) Pub. No.: US 2016/0110818 A1
(43) Pub. Date: Apr. 21, 2016

(54) SYSTEM FOR DYNAMIC FRAUD DETECTION

(71) Applicant: Hartford Fire Insurance Company, Hartford, CT (US)

(72) Inventors: Keren Shemesh, West Hartford, CT (US); Paul J. Edwards, West Hartford, CT (US); Geoffrey P. Hayden, New Milford, CT (US); Andrew D. Preece, Winter Garden, FL (US); Odie Waters, II, Boerne, TX (US)

(21) Appl. No.: 14/697,051

(22) Filed: Apr. 27, 2015

Related U.S. Application Data
(60) Provisional application No. 62/066,631, filed on Oct. 21, 2014.

(51) Int. Cl. G06Q 40/08

(52) U.S. Cl. CPC G06Q 40/08

(57) ABSTRACT

According to some embodiments, data is received indicative of a plurality of insurance claims. It may then be automatically determined that a first insurance claim is associated with a first type of insurance and that a second insurance claim is associated with a second type of insurance different from the first type of insurance. The received data associated with the first insurance claim may be analyzed, in accordance with first fraud detection logic, to determine a first questionable loss status appropriate for the first insurance claim. Similarly, the received data associated with the second insurance claim may be analyzed, in accordance with second fraud detection logic different from the first fraud detection logic, to determine a second questionable loss status appropriate for the second insurance claim. Indications of the first and second questionable loss statuses may then be transmitted (e.g., to a claim handler or a special investigation unit platform).

### CROSS-REFERENCE TO RELATED APPLICATION

The present application claims the benefit of U.S. Patent Application 62/066,631 entitled “SYSTEM FOR DYNAMIC FRAUD DETECTION” and filed on Oct. 21, 2014. The entire content of that application is incorporated herein by reference

### FIELD

The present invention relates to computer systems and more particularly to computer systems that facilitate dynamic detection of insurance fraud.

### BACKGROUND

An insurer may provide payments when claims are made in connection with an insurance policy. For example, an employee who is injured while working might receive payments associated with a workers' compensation insurance policy purchased by his or her employer. Similarly, a person involved in an automobile accident may receive a payment in connection with an automobile insurance policy. The insurer may assign a claim handler to communicate with a claimant, an employer, another insurer, and/or medical service providers to help determine the appropriate amount of payment. In some cases, an insurance claim may be associated with a fraudulent or questionable loss. For example, an employee's injury might not have occurred while he or she was at work, a homeowner might not be truthful regarding the cause of damage to his or her property or exaggerate the extent of a loss, an automobile might have been intentionally set on fire by the owner, etc.

In one approach, a received insurance claim is simply reviewed by a claim handler who looks for suspicious information or patterns in the information that might indicate that the loss is questionable. For example, an insurance claim received from a worker after he or she was terminated from employment might be reviewed to ensure that the claim is legitimate. This approach of leaving fraud detection to the judgment of each claim handler, however, can be a time consuming and error prone task, especially when there are a substantial number of claims, associated with many different types of insurance and damages, to be analyzed. For example, an insurer might receive tens of thousands of new insurance claims each year (which might represent a billion dollars of potential liability). It would therefore be desirable to provide systems and methods to facilitate an automated insurance claim fraud detection process in an automated, efficient, and accurate manner.

### SUMMARY

According to some embodiments, systems, methods, apparatus, computer program code and means may facilitate an automated insurance claim fraud detection process. In some embodiments, a communication device may receive data indicative of a plurality of insurance claims submitted in connection with insurance policies. It may then be automatically determined that a first insurance claim is associated with a first type of insurance and that a second insurance claim is associated with a second type of insurance different from the first type of insurance. The received data associated with the first insurance claim may be analyzed, in accordance with first fraud detection logic, to determine a first questionable loss status appropriate for the first insurance claim. Similarly, the received data associated with the second insurance claim may be analyzed, in accordance with second fraud detection logic different from the first fraud detection logic, to determine a second questionable loss status appropriate for the second insurance claim. Indications of the first and second questionable loss statuses may then be transmitted (e.g., to a claim handler or a special investigation unit platform).

A technical effect of some embodiments of the invention is an improved and computerized method to provide an automated insurance claim fraud detection process. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 is block diagram of a fraud detection system according to some embodiments of the present invention.

FIG. 4 is an example of a method that might be performed according to some embodiments.

FIG. 5 illustrates a screen display of an anti-fraud wizard in accordance with some embodiments.

FIG. 6 is an example of a method that might be performed according to some embodiments.

FIG. 7 is block diagram of a fraud detection tool or platform according to some embodiments of the present invention.

FIG. 8 is a tabular portion of an insurance claim database according to some embodiments.

FIG. 9 is a tabular portion of an anti-fraud wizard database according to some embodiments.

FIG. 10 illustrates a screen display of an anti-fraud overview page in accordance with some embodiments.

FIG. 11 is an information flow diagram in accordance with some embodiments.

FIG. 12 illustrates a screen display of a referral notes page in accordance with some embodiments.

FIG. 13 is a partially functional block diagram that illustrates aspects of a computer system provided in accordance with some embodiments of the invention.

FIG. 14 is a block diagram that provides another representation of aspects of the system of FIG. 13.

FIG. 15 is a flow chart illustrating how a predictive model might be trained according to some embodiments.

FIG. 16 illustrates predictive model inputs according to some embodiments.

FIG. 17 illustrates a handheld device displaying information about an insurance claim processing system in accordance with some embodiments.

### DETAILED DESCRIPTION

An insurer may provide payments when claims are made in connection with an insurance policy, such as a workers' compensation or automobile insurance policy. Note that embodiments may also be associated with other types of insurance, including long term disability insurance, short term disability insurance, flexible combinations of short and long term disability insurance, homeowners insurance, property insurance, general liability insurance, commercial insurance, cyber insurance, extreme weather insurance, and/or personal insurance.

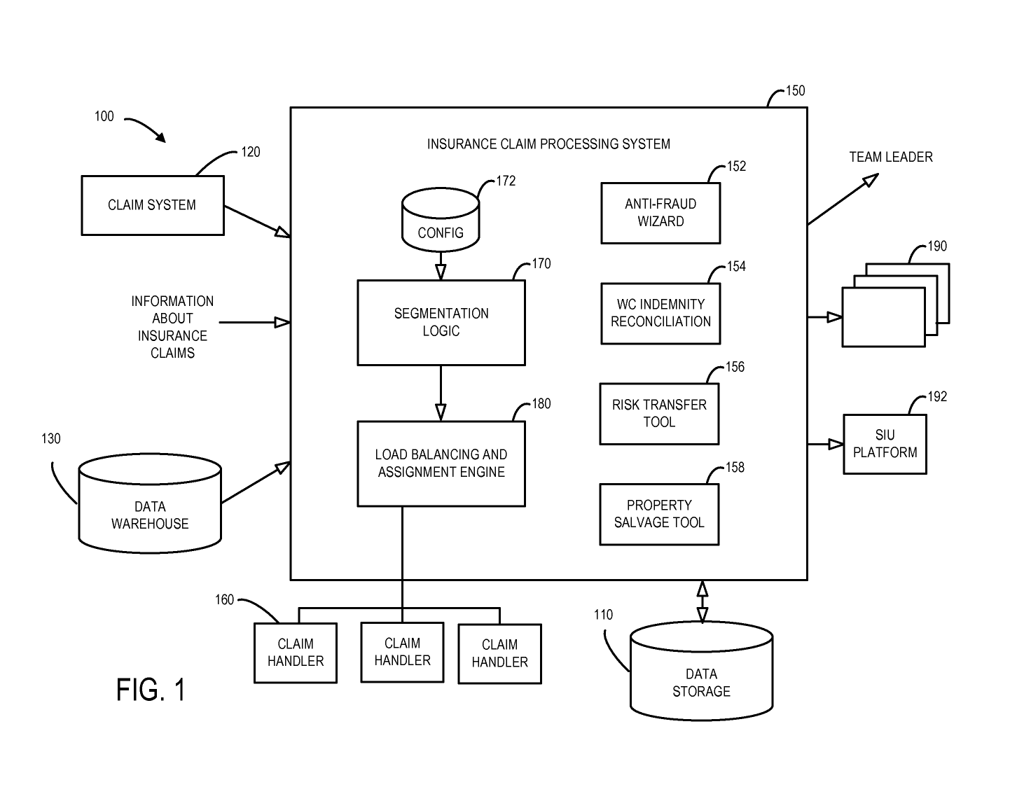

Individually evaluating and determining which insurance claims might be associated with fraud or a questionable loss can be a time consuming, error prone, and difficult task, especially when there are a substantial number of claims to be analyzed. It would therefore be desirable to provide systems and methods to facilitate an automated insurance claim fraud detection process. In particular, some embodiments may provide a data sharing architecture for a network of computers to perform insurance fraud detecting. The architecture may, for example, automatically utilize fraud detection modeling, fraud analytics, text mining, social media analysis, etc. to facilitate detection of potentially fraudulent insurance claims. Note the architecture may enable the system to apply hundreds of rules to a substantially number of claims (e.g., thousands of insurance claims) and generate results in substantially real time. FIG. 1 is block diagram of a system 100 according to some embodiments of the present invention. In particular, the system 100 includes an insurance claim processing system 150 that receives information about insurance claims (e.g., by receiving an electronic file from a team leader, an employer, an employee, an insurance agent, a medical service provider, or a data storage unit 110). According to some embodiments, incoming telephone calls and/or documents from a doctor may be used to create information in a claim system 120 which, in turn, can provide information to the insurance claim processing system 150. In other embodiments, the insurance claim processing system 150 may retrieve information from a data warehouse 130 (e.g., when the insurance claim processing system 150 is associated with an automobile insurance system, some information may be copied from an automobile insurance data warehouse or an electronic police report). In other embodiments, some or all of the information about an insurance claim may be received via a claim submission process.

The insurance claim processing system 150 may, according to some embodiments, include segmentation logic 170 that automatically determines an appropriate segment (e.g., based on the likely complexity or liability) for insurance claims (e.g., in accordance with customizable configurations parameters 172). This claim segment information may then be used by a load balancing and assignment engine 180 to select an appropriate claim handler 160 for each insurance claim. The insurance claim processing system 150 might be, for example, associated with a Personal Computers (PC), laptop computer, an enterprise server, a server farm, and/or a database or similar storage devices. The insurance claim processing system 150 may, according to some embodiments, be associated with an insurance provider.

According to some embodiments, an “automated” insurance claim processing system 150 may facilitate the assignment of insurance claims to appropriate segments and/or claim handlers 160 and perform other functions. For example, the insurance claim processing system 150 may automatically output a recommended claim segment for a received insurance claim (e.g., indicating that the insurance claim belongs in a “high exposure” segment) which may then be used to facilitate assignment of a claim handler 160. As used herein, the term “automated” may refer to, for example, actions that can be performed with little (or no) intervention by a human.

As used herein, devices, including those associated with the insurance claim processing system 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The insurance claim processing system 150 may store information into and/or retrieve information from the data storage 110. The data storage 110 might be associated with, for example, a client, an employer, or insurance policy and might store data associated with past and current insurance claims and/or payments. The data storage 110 may be locally stored or reside remote from the insurance claim processing system 150. As will be described further below, the data storage 110 may be used by the insurance claim processing system 150 to generate predictive models. According to some embodiments, the insurance claim processing system 150 communicates a recommended claim processing workflow (e.g., expedited or normal workflows), such as by transmitting an electronic file to a claim handler 160, a client device, an insurance agent or analyst platform, an email server, a workflow management system, a special investigation unit platform (e.g., to further examine questionable insurance claims), etc. In other embodiments, the insurance claim processing system 150 might output a recommended claim workflow indication to a team leader who might select a claim handler based on that indication or override the indication based on other factors associated with the insurance claim.

According to some embodiments, the insurance claim processing system 150 further includes an anti-fraud wizard 152 (e.g., to help detect inappropriate insurance claims). The anti-fraud wizard 152 may, according to some embodiments, use appropriate fraud detection rules, logic, and user interfaces that are applied based on the specific facts of the insurance claim being processed and/or a predictive model. As used herein, the term “wizard” may refer to, for example, a user interface, software module, or any other device that may guide one or more inputs from a user, such as a claim handler. Note that according to some embodiments the wizard may route information about a claim to an automated claim-handling system. Moreover, the anti-fraud wizard 152 may be associated with hundreds of different sets of items of information, including thousands of questionable loss indicators, action items, etc. that may be tailored to meet the fraud detection needs for different types of insurance policies and claims. According to some embodiments, the anti-fraud wizard 152 may refer insurance claims to claim handlers 160 and/or a Special Investigation Unit platform 192. As used here, the phrase “special investigation unit” may refer to a team or department of an insurer that has special expertise dealing with insurance claims associated with questionable losses. According to some embodiments, the special investigation unit may be associated with a third-party, such as a specialized vendor that is external to the insurance enterprise handling the insurance claim.

Some embodiments may further include a Workers' Compensation (“WC”) indemnity reconciliation tool 154 (e.g., to help a claim handler 160 comply with various jurisdiction based regulations), a risk transfer tool 156 (e.g., to help identify other parties who may have liability in connection with an insurance claim), and/or a property salvage tool 158 (e.g., to help identify situations where value may be identified and/or obtained in connection with an insurance claim). Moreover, the insurance claim processing system 150 may transmit information to other devices 190 or applications, such as email servers, report generators, calendar applications, etc. Note that at least some of the tools and other applications associated with the insurance claim processing system 150 might be incorporated within, or utilize, an electronic spreadsheet, such as the EXCEL® electronic spreadsheet program available from MICROSOFT®.

Although a single insurance claim processing system 150 is shown in FIG. 1, any number of such devices may be included. Moreover, various devices described herein might be combined according to embodiments of the present invention. For example, in some embodiments, the claim processing system 150 and data storage 110 might be co-located and/or may comprise a single apparatus.

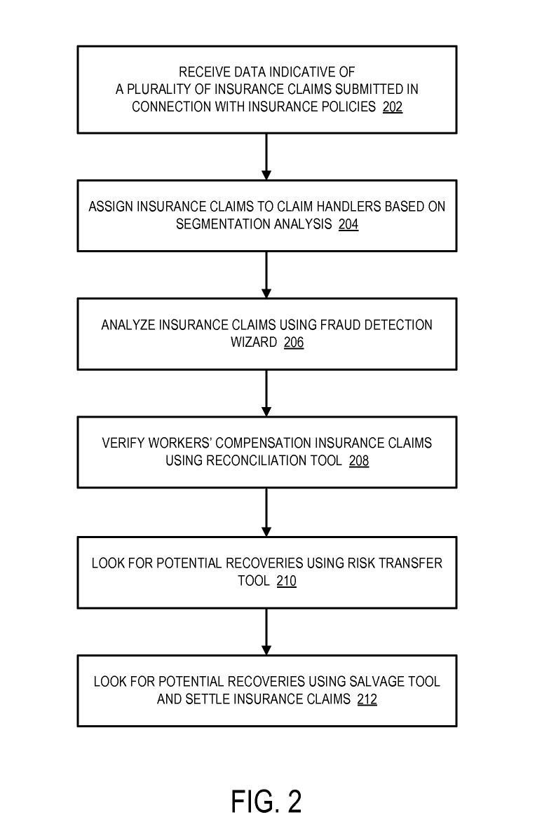

FIG. 2 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, data may be received indicative of a plurality of insurance claims submitted in connection with insurance policies. The insurance claims might be associated with, for example, workers' compensation insurance claims and/or automobile insurance claims. Note that the data indicative of insurance claims might be received via submitted paper claims, a telephone call center, and/or an online claim submission web site.

At 204, insurance claims may be assigned to claim handlers based, at least in part, on a segmentation analysis. For example, an insurance claim might be recognized as requiring highly complex handling (e.g., a claim identified as a “longshore” claim) and thus be assigned to a “specialized” segment. As a result, the claim may be assigned to a particular group of claim handlers who have experience with these types of insurance claims.

At 206, insurance claims may be analyzed using a fraud detection wizard. The fraud detection wizard may, for example, look for suspicious information, patterns, or values within one or more insurance claims (which, when found, may prompt further investigation). Note that not all elements of FIG. 2 are required with respect to embodiments described herein. For example, embodiments may analyze insurance claims using a fraud detection wizard without ever applying the segmentation analysis of 204.

At 208, workers' compensation insurance claims may be verified using a reconciliation tool. For example, different jurisdictions may have different recordkeeping requirement and/or penalties associated with workers' compensation claims and the reconciliation tool may help claim handlers process such claims in an appropriate manner. At 210, embodiments may look for potential recoveries using a risk transfer tool. According to some embodiments, the risk transfer tool might identify other parties (e.g., other insurance companies, employers, etc. who might be liable for at least a portion of the payments associated with an insurance claim). At 212, embodiments may look for potential recoveries using a salvage tool (e.g., the salvage value associated with an automobile accident) and the insurance claims may be settled.

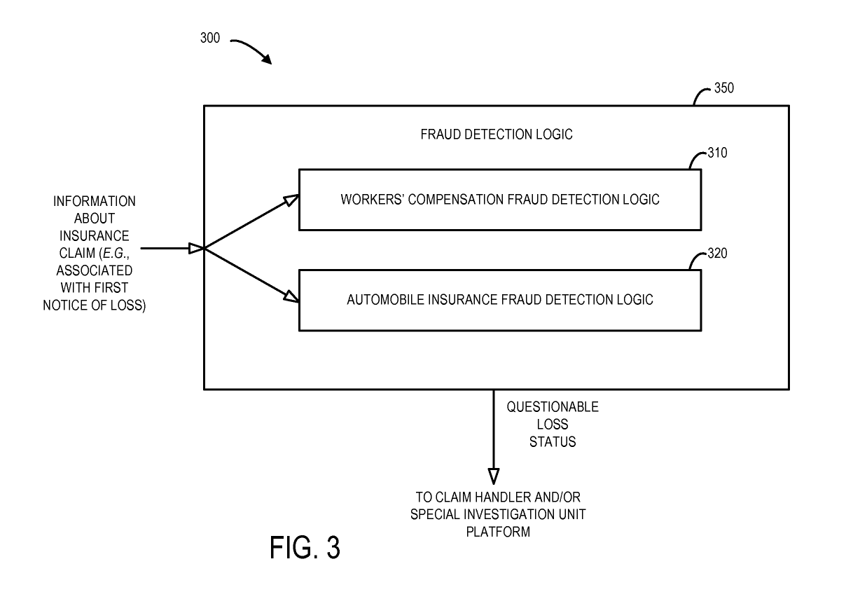

FIG. 3 is block diagram of a fraud detection system 300 according to some embodiments of the present invention. The fraud detection system 300 includes fraud detection logic 350 which may be associated with the anti-fraud wizard 152 described with respect to FIG. 1. According to some embodiments, the fraud detection logic 350 automatically determines a questionable loss status (e.g., based on the timing of a claim, details about an accident, etc.) for insurance claims (e.g., in accordance with pre-defined rules). This fraud detection information may then be transmitted to a claim handler and/or a special investigation unit platform to further examine the insurance claim. Note that different types of insurance and/or damages may be associated with different types of fraud detection logic. For example, as illustrated in FIG. 3, a workers' compensation insurance claim may be processed using workers' compensation fraud detection logic 310 while an insurance claim may be processed using automobile insurance fraud detection logic 320.

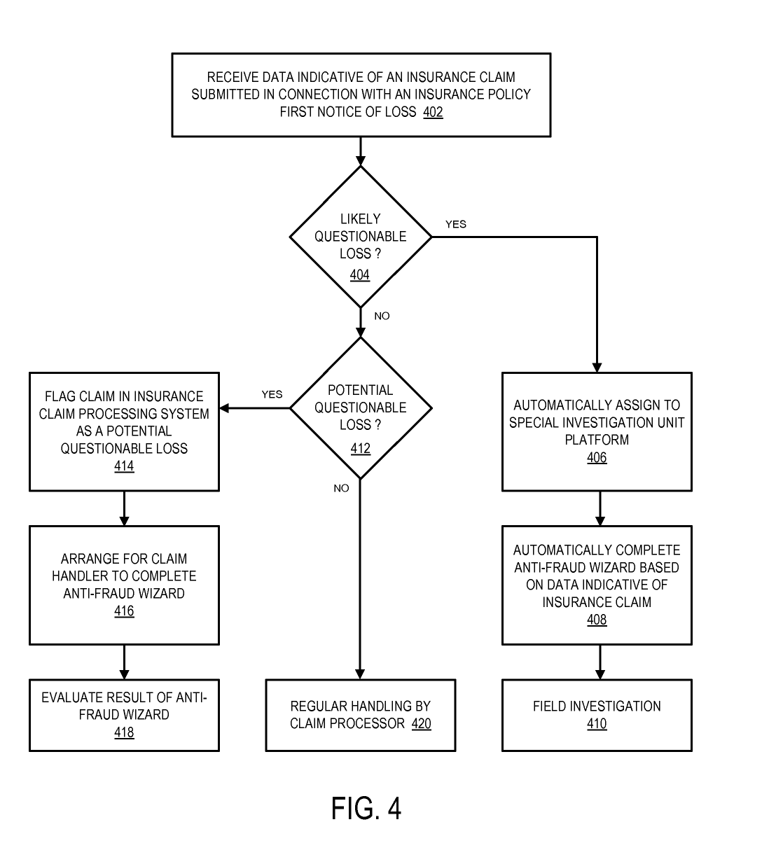

FIG. 4 illustrates a method that might be performed by some or all of the elements of the system 300 described with respect to FIG. 3 according to some embodiments of the present invention. At 402, data may be received indicative of a plurality of insurance claims submitted in connection with insurance policies. The insurance claims might be associated with, for example, workers' compensation claims, business insurance claims, homeowners insurance claims, automobile insurance claims, and/or other types of insurance claims. Note that the data indicative of insurance claims might be received via submitted paper claims, a telephone call center, an online claim submission web page, etc. in connection with a First Notice Of Loss (“FNOL”). Although some embodiments are described with respect to a newly received insurance claim, note that any of the embodiments described herein may be performed in connection with an insurance claim currently being processed by a claim handler. That is, updated information about a first insurance claim might be gathered as the claim matures (e.g., a doctor associated with the claim might be added to a watch list) may cause the system to automatically analyze the updated data to calculate an updated indicator score strength. Based on the updated indicator score strength, an updated questionable loss status may be determined to be appropriate for the first insurance claim. For example, if information about an insurance claim changes (e.g., more information about an injury associated with the claim becomes available), the system may dynamically execute fraud detection logic and automatically adjust the questionable loss status that is associated with the claim. Note that this may, in some cases, result in the insurance claim being automatically moved from the claim handler to a special investigation unit platform.

At 404, it may be automatically determined if the insurance claim is associated with something that is very likely to be considered a questionable loss. For example, a workers' compensation insurance claim for a loss reported within 15 days of an employee's termination might automatically be considered as having a very high likelihood of being a questionable or fraudulent loss. If the insurance claim is likely to be considered a questionable loss at 404, it may be automatically assigned to a special investigation unit platform at 406 for further examination. The special investigation unit platform may, according to some embodiments, be used by parties who have specialized expertise in detecting fraudulent insurance claims. At least a portion of an anti-fraud wizard display may be automatically completed and/or populated with information about the insurance claim at 408. A field investigation about the insurance claim may then begin at 410.

If the insurance claim is not very likely to be considered a questionable loss at 404, it may be automatically determined if the insurance claim is associated with something that is has a relatively high potential of being considered a questionable loss at 412. For example, a workers' compensation insurance claim for an unwitnessed slip and fall injury might automatically be considered as having a relatively high potential of being a questionable or fraudulent loss. If the insurance claim is potentially a questionable loss at 412, it may be automatically flagged in the insurance claim processing system at 414, and a claim handler may enter further information via an anti-fraud wizard at 416. After the anti-fraud wizard information is entered, the data can be evaluated at 418. For example, the additional information might result in the claim being either automatically or manually (by the claim handler) transmitted to the special investigation unit platform. If the insurance claim is not considered a potentially questionable loss at 412, it may undergo normal claim processing by a claim handler at 420.

In the example of FIG. 4, it might be determined that the insurance claim is associated with an automobile insurance policy. If so, embodiments may analyze the received data associated with the insurance claim, in accordance with first fraud detection logic, to determine a questionable loss status appropriate for that insurance claim. Embodiments may analyze the types of damage associated with the insurance claim (e.g., whether multiple people were present, whether the automobile caught on fire, etc.). Embodiment may also analyze one or more hard rules associated with other vehicle insurance policies, rental agreements, etc. As a result of such an analysis, an appropriate questionable loss status for the automobile insurance claim may be output.

If it is instead determined that an insurance claim is associated with workers' compensation insurance policy, embodiments may analyze the received data associated with the insurance claim, in accordance with second fraud detection logic, to determine a questionable loss status appropriate for that particular insurance claim. For example, an anti-fraud wizard may include different questions, and analyze answers in different ways, depending on the type of insurance policy and/or damages that are associated with an insurance claim.

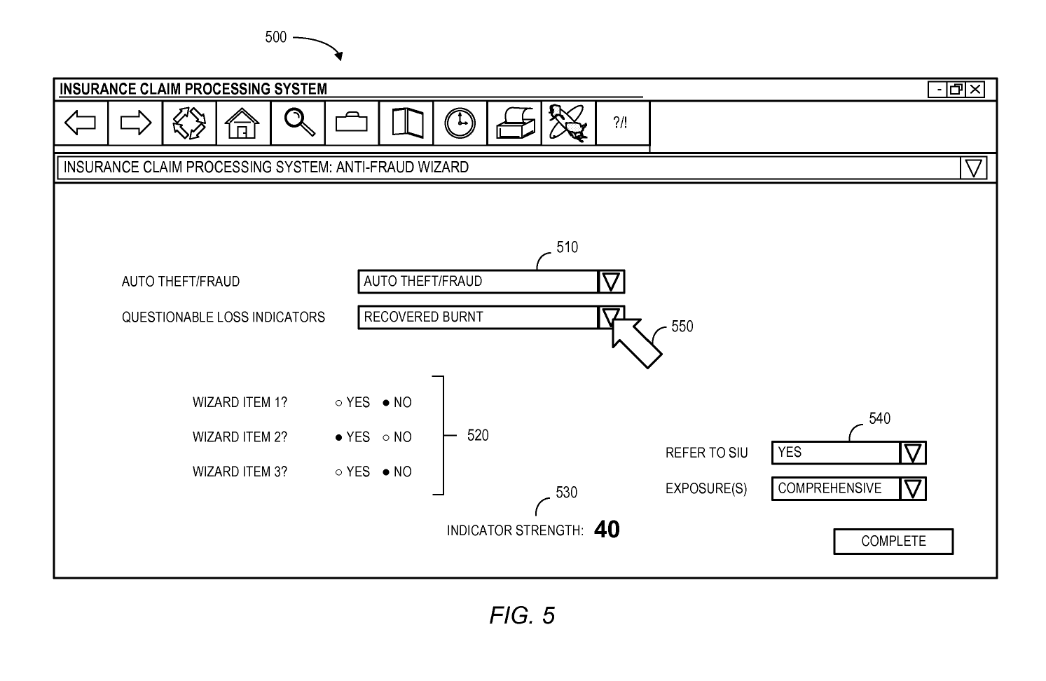

FIG. 5 illustrates a screen display 500 of an anti-fraud wizard in accordance with some embodiments. According to some embodiments, an insurance claim handler may use a first data entry area 510 to define a particular type or category associated with the insurance claim (e.g., an automobile theft or fraud situation where the vehicle was recovered in burnt condition as illustrated in FIG. 5). The claim handler may also input information via wizard items 520 (e.g., by selecting “yes” or “no” for each wizard item 520), each item representing, for example, a particular claim characteristic or action item checklist step that may need to be performed by the claim handler.

By way of examples only, wizard items 520 might include customized questions (automatically selected and presented to the claim handler based on the type of insurance and/or details about the insurance claim) such as:

Was the loss reported with 15 days prior to termination?

Was the loss reported after retirement?

Was there at least 1 prior claim of the same body part within the last 3 years?

Is physician known for handling suspect claims?

Was incident not promptly reported to supervisor?

Did injured worker move out of state or country shortly after reporting claim?

Has there been extensive or unnecessary treatment for a minor injury?

Other wizard items 520 may be associated with a set of steps that should be performed by the claim handler (automatically selected and presented to the claim handler based on the type of insurance and/or details about the insurance claim) such as:

Has coverage been verified?

Have all parties involved been contacted?

Have recorded statements of all parties involved been obtained?

Have the name, address, and date of birth of all partied been confirmed?

The answers provided to by the claim handler responsive to these wizard items 520 may be automatically and dynamically evaluated by fraud detection logic (specific to the type of insurance claim being processed) to determine a questionable loss status for the claim.

An overall questionable loss indicator strength 530 may be calculated and displayed to the claim handler based on, for example, the information provided in the first data entry area 510 and/or the wizard item 520 inputs. The indicator strength 530 may comprise, for example, a percentage value, category or level of risk, a color (e.g., red indicating a high likelihood of fraud), etc. A second data entry area 540 may be used by the claim handler to refer one or more claim exposures that should be examined by a special investigation unit platform. According to some embodiments, the referral to SIU in the data entry area 540 may be automatically populated by the anti-fraud wizard (e.g., based on inputs received from the claim handler and appropriate fraud detection logic). Note that the claim handler may provide any of this information to the display 500 using, for example, a touchscreen or computer mouse icon 550.

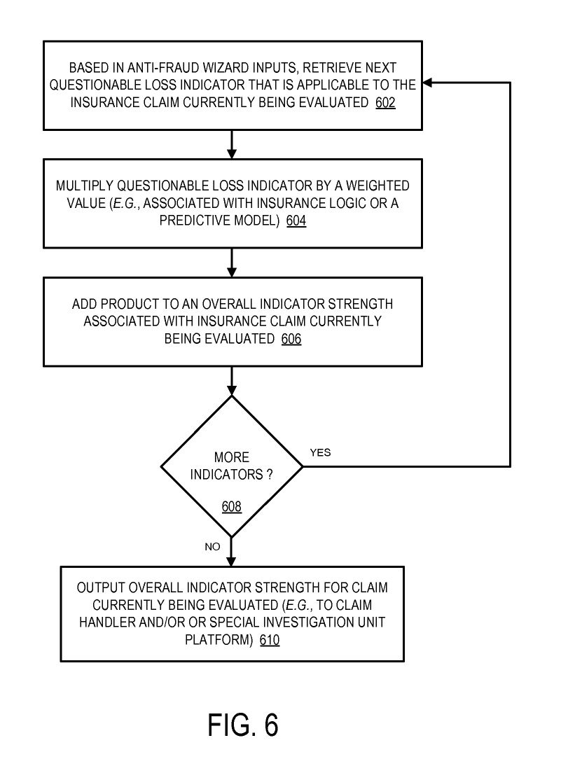

The overall indicator strength 530 might be calculated in a number of different ways. FIG. 6 is an example of a method that might be performed according to some embodiments. At 602, a questionable loss indictor applicable to an insurance claim being evaluated may be retrieved (e.g., based on information associated with the insurance claim, such as anti-fraud wizard data that was provided by a claim handler). At 604, the questionable loss indicator may be multiplied by a weighted value (e.g., associated with a predictive model). For example, a questionable loss indicator of “multiple parties were injured in a vehicle” might initially be identified as being associated with an insurance claim (and assigned a default value of “1”). This indicator might be multiplied by a weighted value of “0.5” (depending on how historically accurate that particular indicator has been in identifying fraudulent insurance claims).

The product of the questionable loss indicator multiplied by the associated weighted value may then be added at 606 to an overall indictor strength for the insurance claim currently being evaluated. If there are additional indicators associated with the insurance claim at 608, the process continues at 602. When there are no more indicators associated with the insurance claim at 608 (that is, all indicators applicable to the type of insurance or damage being evaluated have been considered), the overall indicator strength may be output at 610 (e.g., to a claim handler and/or a special investigation unit platform). For example, all insurance claims with an indicator strength above a pre-determined threshold value might be routed to a special investigation unit platform for further review.

According to some embodiments, an overall indicator strength value ISₒᵥₑᵣₐₗₗ may be calculated as follows:

$$I {S}_{overall} = {\sum }_{x = 1}^{n} ( {I}_{x} \times {w}_{x} )$$

where n represents the total number of questionable loss indicators, lₓ represents the value for each particular questionable loss indicator (e.g., with “0” meaning the indicator is not present and “1” meaning that the indicator is present), and wₓ represents a weighting value for each particular questionable loss indicator (e.g., associated with a predictive model). The calculated ISₒᵥₑᵣₐₗₗ value may be used, for example, along with one or more threshold cutoff values to automatically flag an insurance claim file, to automatically transmit the file to a special investigation unit platform, etc.

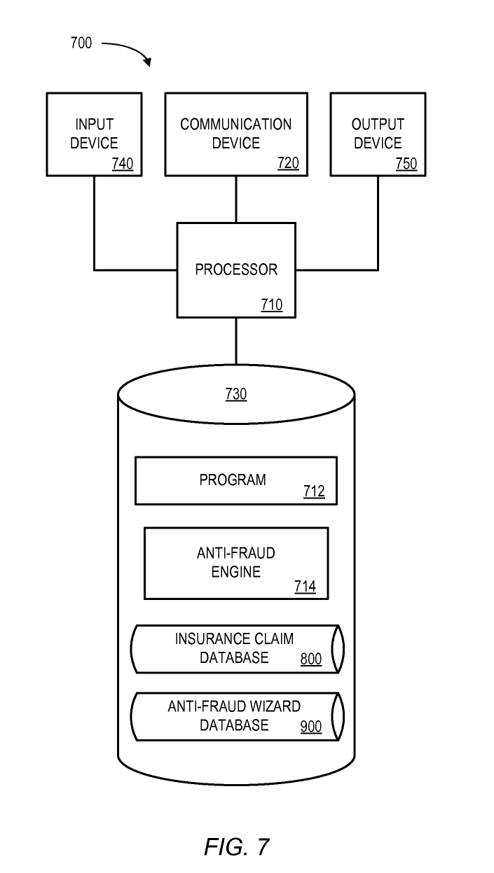

Note that the embodiments described herein may be implemented using any number of different hardware configurations. For example, FIG. 7 illustrates a fraud detection platform 700 that may be, for example, associated with the systems 100, 300 of FIGS. 1 and 3. The fraud detection platform 700 comprises a processor 710, such as one or more commercially available Central Processing Units (CPUs) in the form of one-chip microprocessors, coupled to a communication device 720 configured to communicate via a communication network (not shown in FIG. 7). The communication device 720 may be used to communicate, for example, with one or more claim systems, remote team leaders, load balancing and assignment engines, and/or claim handler devices. The fraud detection platform 700 further includes an input device 740 (e.g., a mouse and/or keyboard to enter information about fraud detection logic or wizard answers) and an output device 750 (e.g., to output wizard information or questionable loss statuses for insurance claims).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or an anti-fraud engine 714 for controlling the processor 710. The processor 710 performs instructions of the programs 712, 714, and thereby operates in accordance with any of the embodiments described herein. For example, the processor 710 may receive data indicative of a plurality of insurance claims submitted in connection with insurance policies. The processor 710 may then automatically determine that a first insurance claim is associated with a first type of insurance and that a second insurance claim is associated with a second type of insurance. The received data associated with the first insurance claim may be analyzed by the processor 710 in accordance with first fraud detection logic to determine a first questionable loss status appropriate for the first insurance claim. Similarly, the received data associated with the second insurance claim may be automatically analyzed by the processor 710 in accordance with second fraud detection logic to determine a second questionable loss status appropriate for the second insurance claim. Indications of the first and second questionable loss statuses may then be transmitted (e.g., to a claim handler and/or special investigation unit platform).

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the fraud detection platform 700 from another device; or (ii) a software application or module within the fraud detection platform 700 from another software application, module, or any other source.

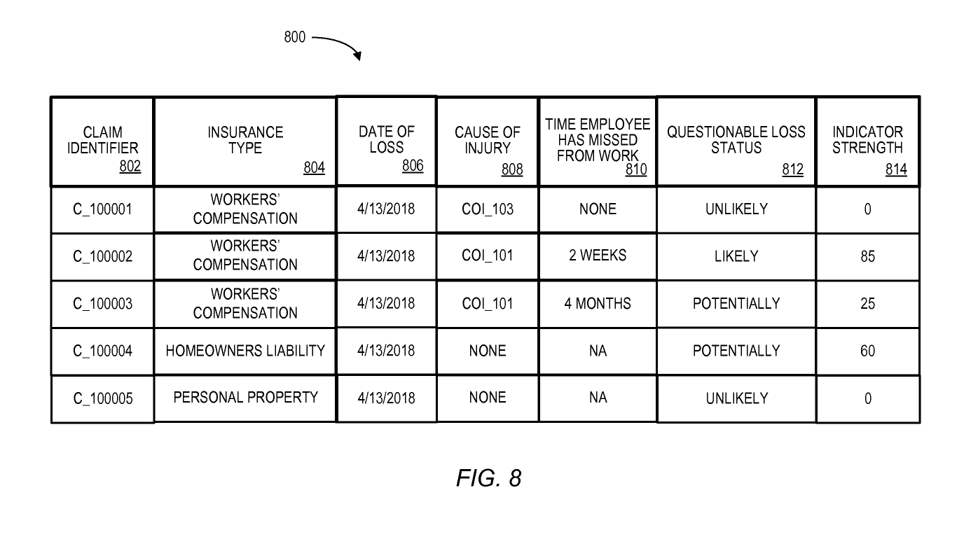

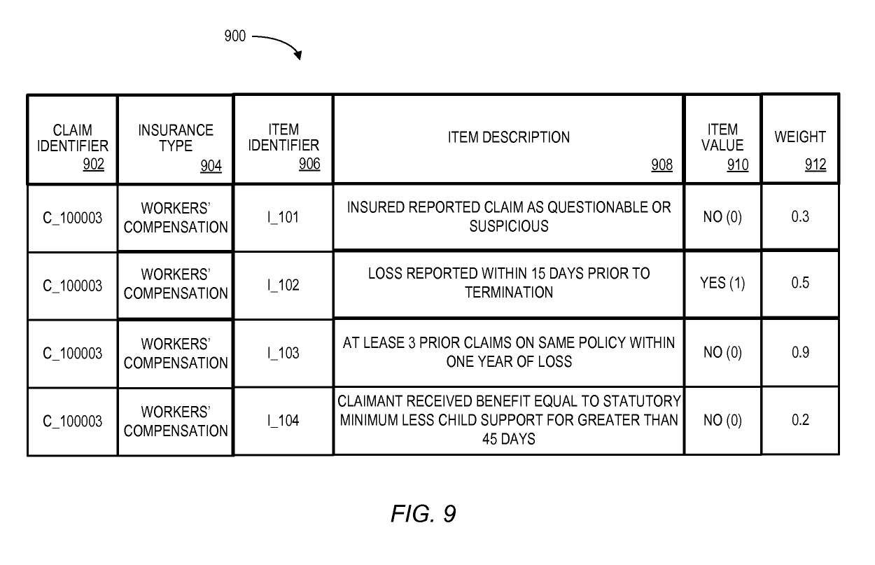

In some embodiments (such as shown in FIG. 7), the storage device 730 further stores an insurance claim database 800 and an anti-fraud wizard database 900. Examples of databases that may be used in connection with the fraud detection platform 700 will now be described in detail with respect to FIGS. 8 and 9. Note that the database described herein is only one example, and additional and/or different information may be stored therein. Moreover, various databases might be split or combined in accordance with any of the embodiments described herein. For example, insurance claim database 800 and anti-fraud wizard database 900 might be incorporated within the anti-fraud engine 714.

Referring to FIG. 8, a table is shown that represents the insurance claim database 800 that may be stored at the fraud detection platform 700 according to some embodiments. The table may include, for example, entries identifying insurance claims being processed in accordance with some embodiments described herein. The table may also define fields 802, 804, 806, 808, 810, 812, 814 for each of the entries. The fields 802, 804, 806, 808, 810, 812, 814 may, according to some embodiments, specify: a claim identifier 802, an insurance type 804, a date of loss 806, a cause of injury 808, an amount of time an employee has missed from work 810, a questionable loss status 812, and an indicator strength 814. The insurance claim database 800 may be created and updated, for example, based on insurance claim information electrically received in substantially real time or on a periodic basis.

The claim identifier 802 may be, for example, a unique alphanumeric code identifying an insurance claim that has been submitted in connection with an insurance policy. The insurance type 804 may indicate the type of insurance associated with the claim and/or policy. For example, as illustrated in FIG. 8 the insurance claim having a claim identifier of “C_100004” is associated with “homeowners liability” insurance. The date of loss 806 might indicate and when an injury occurred and/or when a claim was submitted. The cause of injury 808 might indicate what type of injury is associated with the insurance claim and the amount of time an employee has missed from work 810 might indicate, for example, that a claimant has already been away from work for 2 weeks because of his or her injury. The questionable loss status 812 might reflect how likely it is that the insurance claim is associated with insurance fraud. The questionable loss status 812 might indicate, for example, that the insurance claim is “unlikely” to be associated with fraud (and should therefore undergo normal processing by a claim handler) or “likely” to be associated with fraud (and should therefore automatically be forwarded to a special investigation unit platform).

According to some embodiments, the questionable loss status 812 may instead indicate that the insurance claim is “potentially” associated with insurance fraud, in which case a claim handler might enter further information via a fraud detection wizard (after which, the questionable loss status 812 may be updated as appropriate). The indicator strength 814 might reflect, for example, a degree of risk associated with the questionable loss status 812 (e.g., a percentage calculated as described with respect to FIG. 6).

FIG. 9 is a tabular portion of an anti-fraud wizard database 900 that may be stored at the fraud detection platform 700 according to some embodiments. The table may include, for example, entries identifying checklist items, insurance claim information, etc. associated with insurance claims. The table may also define fields 902, 904, 906, 908, 910, 912 for each of the entries. The fields 902, 904, 906, 908, 910, 912 may, according to some embodiments, specify: a claim identifier 902, an insurance type 904, an item identifier 906, an item description 908, an item value 910, and a weight 912. The anti-fraud wizard database 900 may be created and updated, for example, by an anti-fraud wizard designer and be dynamically updated based on a type of insurance claim being evaluated, a type of damage, information received from a claim handler, etc.

The claim identifier 902 may be, for example, a unique alphanumeric code identifying an insurance claim that has been submitted in connection with an insurance policy and might be based on or associated with the claim identifier 802 in the insurance claim database 800. Similarly, the insurance type 904 may indicate the type of insurance associated with the claim and/or policy and may be based on or associated with the insurance type 804 in the insurance claim database 800.

Note that different insurance types 904 may be associated with different questionable loss indicators and/or checklist action items. According to some embodiments, for each insurance claim in the anti-fraud wizard database 900 a set of item identifiers 906 and associated item descriptions 908 may be provided (e.g., selected based on the insurance type 904). In the example, of FIG. 9, a “workers' compensation” insurance claim is associated with item identifiers 906 “I_101” through “I_104.” This information might be used, for example, to be displayed to a claim handler on an anti-fraud wizard. The item value 910 might indicate the claim handlers response to each item via the anti-fraud wizard (e.g., with “no” being assigned a value of “0” because it is not present in the claim and “yes” being assigned a value of “1” because it is present in the claim). The weight 921 might reflect how useful that item has been in the past to detect fraudulent insurance claims (e.g., as determined in connection with a predictive model trained with historical insurance claim and/or loss data).

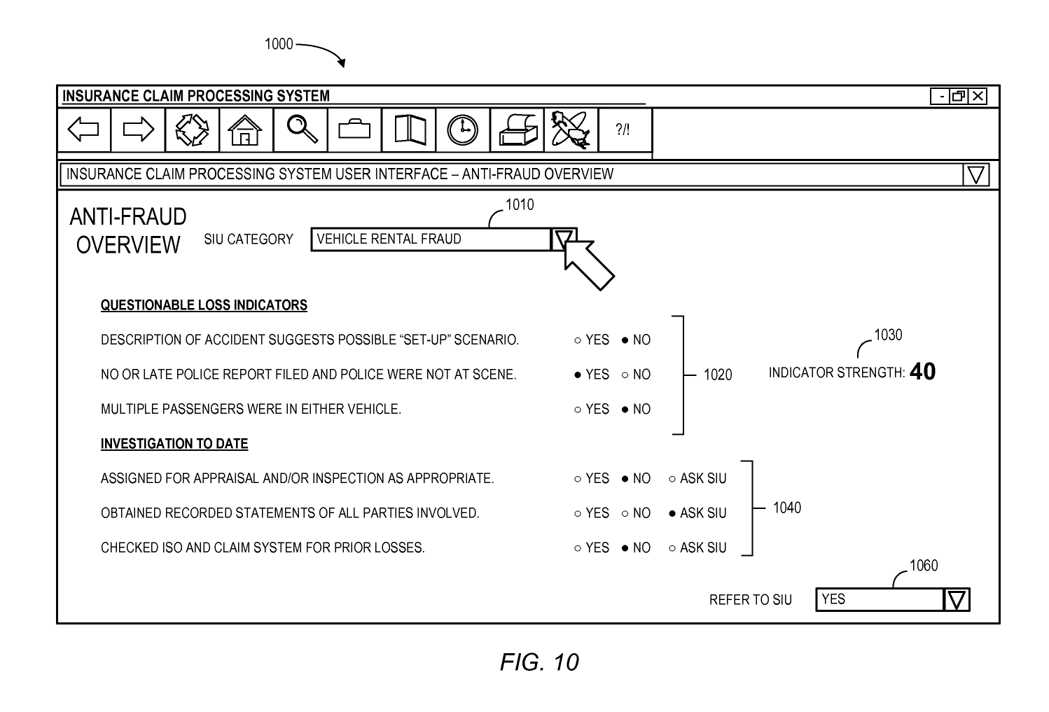

FIG. 10 illustrates a screen display 1000 of an anti-fraud overview page in accordance with some embodiments. The display 1000 includes a Special Investigation Unit (“SIU”) category selection 1010 that might be automatically determined based on claim information or selected by a claim handler. In either case, the SIU category selection 1010 may automatically and dynamically determine a set of questionable loss indicators 1020 that are displayed to the claim handler. Note that the claim handler might indicate “yes” or “no” in connection with each item in the questionable loss indicators 1020. The display 1000 also includes an overall indicator strength 1030 associated with his or her responses to the questionable loss indicators 1020 (which may, in some embodiments, be a percentage value). The display 1000 further includes investigation to date items 1040, which may comprise a checklist of action items that may be performed by the claim handler. As before, the claim handler might indicate “yes” or “no” in connection with each investigation to date items 1040. According to some embodiment, the claim handler might also select “ask SIU” in response to one or more of the investigation to date items 1040. Such an action may, for example, result in a message being automatically transmitted to a special investigation unit platform (e.g., asking a special investigation unit to provide further guidance with respect to that particular item). Such an approach may, for example, improve and streamline communications between claim handlers and special investigation unit team members and improve an insurer's ability to detect fraudulent claims. The display 1000 also includes a “Refer to SIU” selection that can be completed by the claim handler as appropriate and/or be automatically selected by the insurance claim processing system (e.g., based on the questionable loss indicator 1020 answers and/or the indicator strength 1030 value).

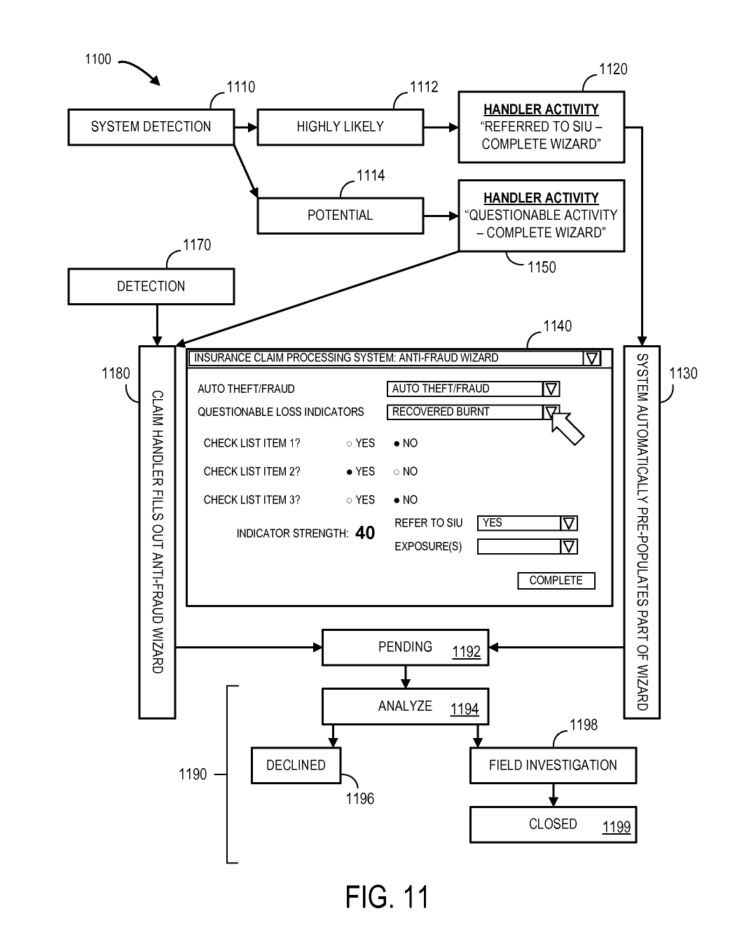

FIG. 11 is an information flow diagram 1100 in accordance with some embodiments. Initially, a system detection 1110 may occur. The system detection 1110 may be associated with a “highly likely” condition 1112 that occurs prior to a handler completing an anti-fraud wizard based on pre-defined conditions that may require a direct referral to a SIU platform. The system may, for example, identify a particular condition as well as a respective category and/or questionable loss indicators and instruct the handler to complete 1120 any wizard 1140 items that were not automatically pre-populated 1130.

The system detection 1110 may instead be associated with a “potential” condition 1114 that occurs after the claim handler completes at least a portion of the wizard based on pre-defined conditional that may require further investigation by the claim handler. In this case, the potential condition may be flagged and the claim handler may be instructed 1150 to complete 1180 the anti-fraud wizard 1140. Note that a detection 1170 by a claim handler might also occur, such as when he or she simply notices something unusual or suspicious about a particular insurance claim.

In either case, when the anti-fraud wizard 1140 is completed, the claim may be considered “pending” 1192 before a SIU platform 1190. After the platform 1190 (or team member) analyzes 1194 the pending claim, it may be declined 1196 (e.g., as not being fraudulent) and no further investigation might occur. If the SIU platform 1190 accepts the claim, a field investigation 1198 may be performed and the result of the investigation 1198 may result in the matter being closed 1199 (e.g., after an ultimate fraud determination is made by the SIU platform 1190).

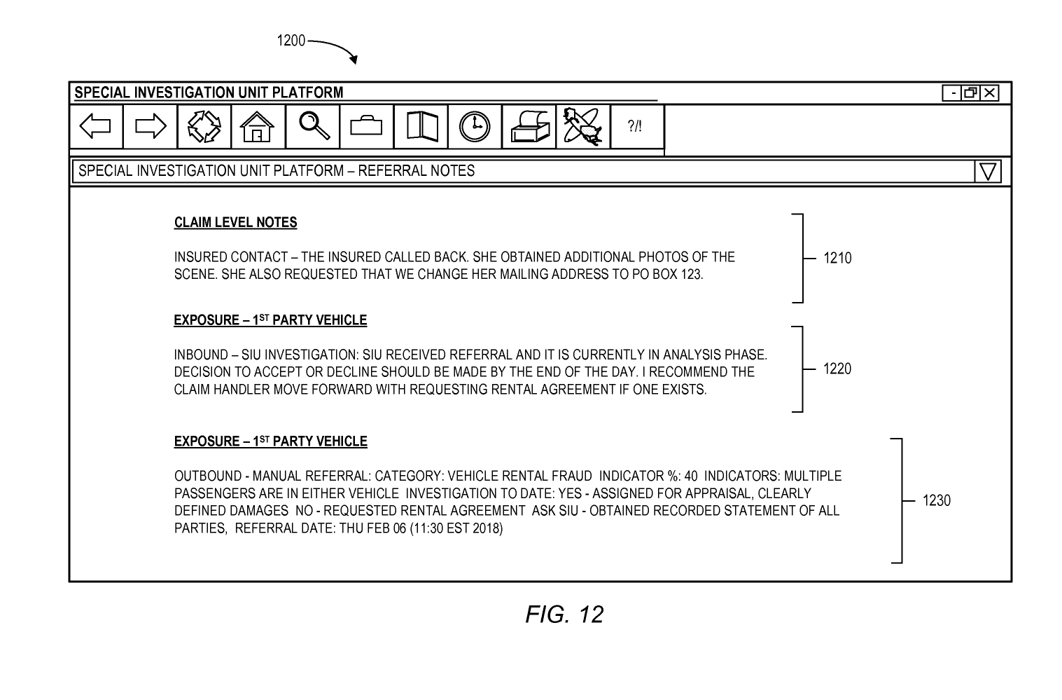

Note the portions of the anti-fraud wizard 1140 may be automatically populated by the system. Further note that information may be automatically and/or manually transmitted to the SIU platform 1190. For example, FIG. 12 illustrates a screen display 1200 of a SIU platform referral notes page in accordance with some embodiments. The display 1200 includes claim level notes 1210. The claim level notes 1210 may indicate, for example, actions that have been performed by the claim handler in connection with the processing of the insurance claim. The display may further include inbound notes associated with a particular insurance claim exposure 1220 (e.g., an injury to a particular party, vehicle, house, etc.). The inbound notes 1220 may, for example, include updates about the status of a claim pending before the SIU platform, and recommendations being made from the SIU team to the claim handler. The display may further include outbound notes associated with a particular insurance claim exposure 1230. The outbound notes 1230 may, for example, be automatically generated based on a claim handler's answers to question items on an anti-fraud wizard and/or include an indicator strength value that was automatically and dynamically generated.

Thus, fraud detection logic and/or anti-fraud wizards may facilitate the processing of insurance claims. According to some embodiments, a predictive model may be used in connection with the fraud detection and/or anti-fraud wizard processes. As used herein, the phrase “predictive model” might refer to, for example, any of a class of algorithms that are used to understand relative factors contributing to an outcome, estimate unknown outcomes, discover trends, and/or make other estimations based on a data set of factors collected across prior trials. Note that a predictive model might refer to, but is not limited to, methods such as ordinary least squares regression, logistic regression, decision trees, neural networks, generalized linear models, and/or Bayesian models. The predictive model might be trained with historical claim transaction data, and be applied to current claim transactions to determine how the current claim transactions should be handled. Both the historical claim transaction data and data representing the current claim transactions might include, according to some embodiments, indeterminate data or information extracted therefrom. For example, such data/information may come from narrative and/or medical text notes associated with a claim file.

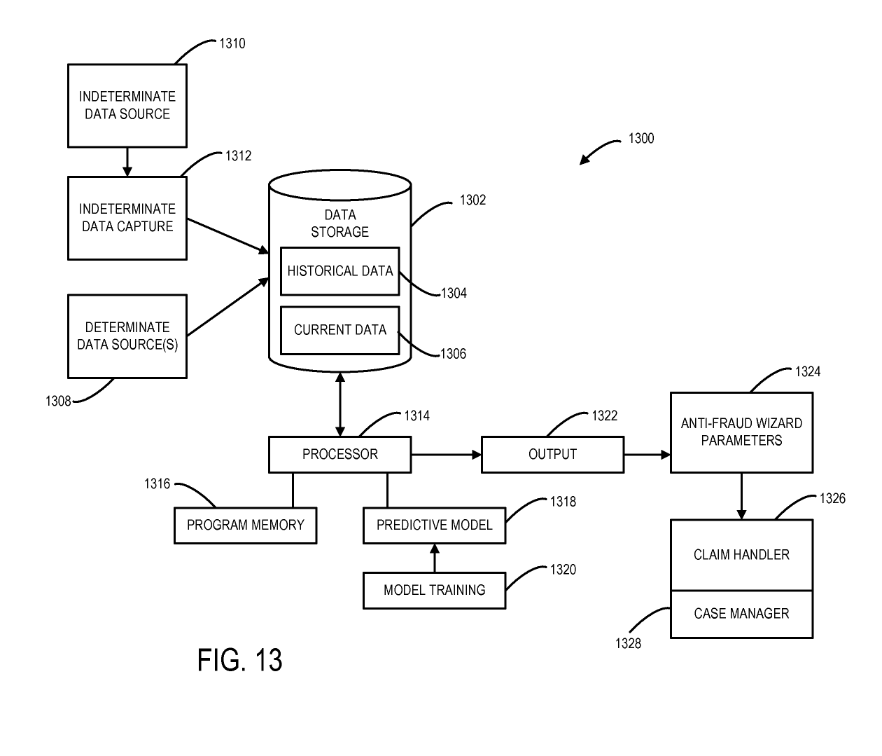

Features of some embodiments associated with a predictive model will now be described by first referring to FIG. 13. FIG. 13 is a partially functional block diagram that illustrates aspects of a computer system 1300 provided in accordance with some embodiments of the invention. For present purposes it will be assumed that the computer system 1300 is operated by an insurance company (not separately shown) for the purpose of referring certain claims to insurance claim workflows and/or handlers as appropriate.

The computer system 1300 includes a data storage module 1302. In terms of its hardware the data storage module 1302 may be conventional, and may be composed, for example, by one or more magnetic hard disk drives. A function performed by the data storage module 1302 in the computer system 1300 is to receive, store and provide access to both historical claim transaction data (reference numeral 1304) and current claim transaction data (reference numeral 1306). As described in more detail below, the historical claim transaction data 1304 is employed to train a predictive model to provide an output that indicates how a claim should by assigned to claim handler, and the current claim transaction data 1306 is thereafter analyzed by the predictive model. Moreover, as time goes by, and results become known from processing current claim transactions, at least some of the current claim transactions may be used to perform further training of the predictive model. Consequently, the predictive model may thereby adapt itself to changing claim patterns.

Either the historical claim transaction data 1304 or the current claim transaction data 1306 might include, according to some embodiments, determinate and indeterminate data. As used herein and in the appended claims, “determinate data” refers to verifiable facts such as the date of birth, age or name of a claimant or name of another individual or of a business or other entity; a type of injury, accident, sickness, or pregnancy status; a medical diagnosis; a date of loss, or date of report of claim, or policy date or other date; a time of day; a day of the week; a vehicle identification number, a geographic location; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files. Indeterminate data extracted from medical notes or accident reports might be associated with, for example, an amount of loss and/or details about how an accident occurred.

The determinate data may come from one or more determinate data sources 1308 that are included in the computer system 1300 and are coupled to the data storage module 1302. The determinate data may include “hard” data like the claimant's name, date of birth, social security number, policy number, address; the date of loss; the date the claim was reported, etc. One possible source of the determinate data may be the insurance company's policy database (not separately indicated). Another possible source of determinate data may be from data entry by the insurance company's claims intake administrative personnel.

The indeterminate data may originate from one or more indeterminate data sources 1310, and may be extracted from raw files or the like by one or more indeterminate data capture modules 1312. Both the indeterminate data source(s) 1310 and the indeterminate data capture module(s) 1312 may be included in the computer system 1300 and coupled directly or indirectly to the data storage module 1302. Examples of the indeterminate data source(s) 1310 may include data storage facilities for document images, for text files (e.g., claim handlers' notes) and digitized recorded voice files (e.g., claimants' oral statements, witness interviews, claim handlers' oral notes, etc.). Examples of the indeterminate data capture module(s) 1312 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual. For example, claim handlers' opinions may be extracted from their narrative text file notes.

The computer system 1300 also may include a computer processor 1314. The computer processor 1314 may include one or more conventional microprocessors and may operate to execute programmed instructions to provide functionality as described herein. Among other functions, the computer processor 1314 may store and retrieve historical claim transaction data 1304 and current claim transaction data 1306 in and from the data storage module 1302. Thus the computer processor 1314 may be coupled to the data storage module 1302.

The computer system 1300 may further include a program memory 1316 that is coupled to the computer processor 1314. The program memory 1316 may include one or more fixed storage devices, such as one or more hard disk drives, and one or more volatile storage devices, such as RAM devices. The program memory 1316 may be at least partially integrated with the data storage module 1302. The program memory 1316 may store one or more application programs, an operating system, device drivers, etc., all of which may contain program instruction steps for execution by the computer processor 1314.

The computer system 1300 further includes a predictive model component 1318. In certain practical embodiments of the computer system 1300, the predictive model component 1318 may effectively be implemented via the computer processor 1314, one or more application programs stored in the program memory 1316, and data stored as a result of training operations based on the historical claim transaction data 1304 (and possibly also data resulting from training with current claims that have been processed). In some embodiments, data arising from model training may be stored in the data storage module 1302, or in a separate data store (not separately shown). A function of the predictive model component 1318 may be to determine appropriate fraud detection logic and/or claim assignment processes (e.g., an automatic assignment to a SIU platform). The predictive model component may be directly or indirectly coupled to the data storage module 1302.

The predictive model component 1318 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1300 includes a model training component 1320. The model training component 1320 may be coupled to the computer processor 1314 (directly or indirectly) and may have the function of training the predictive model component 1318 based on the historical claim transaction data 1304. (As will be understood from previous discussion, the model training component 1320 may further train the predictive model component 1318 as further relevant claim transaction data becomes available.) The model training component 1320 may be embodied at least in part by the computer processor 1314 and one or more application programs stored in the program memory 1316. Thus the training of the predictive model component 1318 by the model training component 1320 may occur in accordance with program instructions stored in the program memory 1316 and executed by the computer processor 1314.

In addition, the computer system 1300 may include an output device 1322. The output device 1322 may be coupled to the computer processor 1314. A function of the output device 1322 may be to provide an output that is indicative of (as determined by the trained predictive model component 1318) particular fraud detection information for the current claim transactions. The output may be generated by the computer processor 1314 in accordance with program instructions stored in the program memory 1316 and executed by the computer processor 1314. More specifically, the output may be generated by the computer processor 1314 in response to applying the data for the current claim transaction to the trained predictive model component 1318. The output may, for example, be a true/false flag or a number within a predetermined range of numbers. In some embodiments, the output device may be implemented by a SIU table program or program module executed by the computer processor 1314 in response to operation of the predictive model component 1318.

Still further, the computer system 1300 may include an anti-fraud wizard parameters module 1324. The anti-fraud wizard parameters module 1324 may be implemented in some embodiments by a software module executed by the computer processor 1314. The anti-fraud wizard parameters module 1324 may have the function of directing workflow based on the output from the output device. Thus the anti-fraud wizard parameters module 1324 may be coupled, at least functionally, to the output device 1322. In some embodiments, for example, the anti-fraud wizard parameters module 1324 may direct workflow by referring, to a claim handler 1326 or SIU platform, current claim transactions analyzed by the predictive model component 1318 and found to be associated with various likelihoods of fraud. In some embodiments, these current claim transactions may be referred to case manager 1328 who is associated with the claim handler 1326. The claim handler 1326 may be a part of the insurance company that operates the computer system 1300, and the case manager 1328 might be an employee of the insurance company.

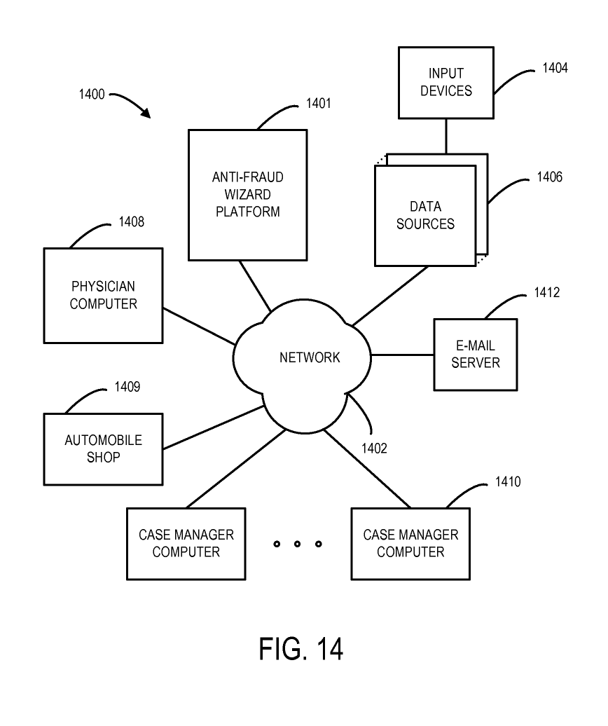

FIG. 14 is another block diagram that presents a computer system 1400 in a somewhat more expansive or comprehensive fashion (and/or in a more hardware-oriented fashion). The computer system 1400, as depicted in FIG. 14, includes an anti-fraud wizard platform 1401 to automatically and selectively assess newly received insurance claims for the insurance company (as well as claims currently being processed when new data becomes available). As seen from FIG. 14, the computer system 1400 may further include a conventional data communication network 1402 to which the anti-fraud wizard platform 1401 is coupled.

FIG. 14 also shows, as parts of computer system 1400, data input device(s) 1404 and data source(s) 1406, the latter (and possibly also the former) being coupled to the data communication network 1402. The data input device(s) 1404 and the data source(s) 1406 may collectively include the devices 1308, 1310 and 1312 discussed above with reference to FIG. 13. More generally, the data input device(s) 1404 and the data source(s) 1406 may encompass any and all devices conventionally used, or hereafter proposed for use, in gathering, inputting, receiving and/or storing information for insurance company claim files.

Still further, FIG. 14 shows, as parts of the computer system 1400, personal computer 1408 assigned for use by one or more physicians (who may be associated with the insurance company's long term disability insurance program), automobile shop computer 1409 (e.g., to transmit repair estimates), and personal computers 1410 assigned for use by case managers (who might also be associated with team leaders and/or claim handlers the long term disability insurance program). The personal computers 1408, 1409, 1410 may be coupled to the data communication network 1402.

Also included in the computer system 1400, and coupled to the data communication network 1402, is an electronic mail server computer 1412. The electronic mail server computer 1412 provides a capability for electronic mail messages to be exchanged among the other devices coupled to the data communication network 1402. Thus, the electronic mail server computer 1412 may be part of an electronic mail system included in the computer system 1400. The computer system 1400 may also be considered to include further personal computers (not shown), including, e.g., computers which are assigned to individual claim handlers or other employees of the insurance company.

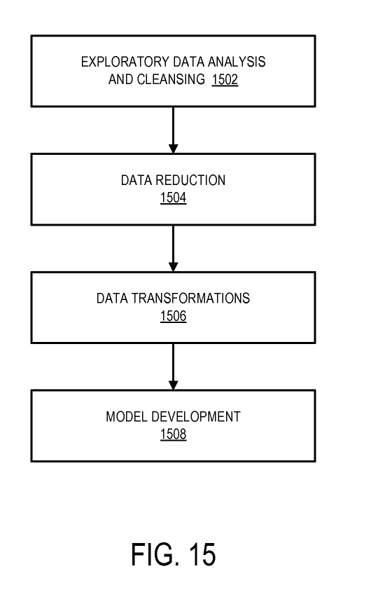

According to some embodiments, the anti-fraud wizard platform 1401 uses a predictive model to facilitate a detection of questionable insurance losses. Note that the predictive model might be designed and/or trained in a number of different ways. For example, FIG. 15 is a flow chart illustrating how a predictive model might be created according to some embodiments. At 1502, data to be input to the predictive model may be analyzed, scrubbed, and/or cleaned. This process might involve a broad review of the relevant variables that may be included in the sample data. Variables might be examined for the presence of erroneous values, such as incorrect data types or values that don't make sense. Observations with such “noisy” data or missing data may be removed from the sample. Similarly, any data points that represent outliers may also be managed.

At 1504, a data reduction process might be performed. This might occur, for example, between variables in the data sample and/or within specific variables. According to some embodiments, certain variables may be associated with one another and the number of these variables may be reduced. For example, it might be noted that back injuries should not be given special consideration. Within certain variables, the raw values may represent a level of information that is too granular. These raw values might then be categorized to reduce the granularity. A goal of the data reduction process may be to reduce the dimensionality of the data by extracting factors or clusters that may account for the variability in the data.

At 1506, any necessary data transformations may be performed. Transformations of dependent and/or independent variables in statistical models can be useful for improving interpretability, model fit, and/or adherence to modeling assumptions. Some common methods may include normalizations of variables to reduce the potential effects of scale and dummy coding or other numeric transformations of character variables.

Once these steps are complete, the predictive model may be developed at 1508. Depending on the nature of the desired prediction, various modeling techniques may be utilized and compared. The list of independent variables may be narrowed down using statistical methods as well as business judgment. Lastly, the model coefficients and/or weights may be calculated and the model algorithm may be completed. For example, it might be determined that back injuries are more often associated with questionable insurance losses (and thus, according to some embodiments, a back injury might be weighted more as compared to a shoulder injury and thus be more likely to end up in with the SIU team).

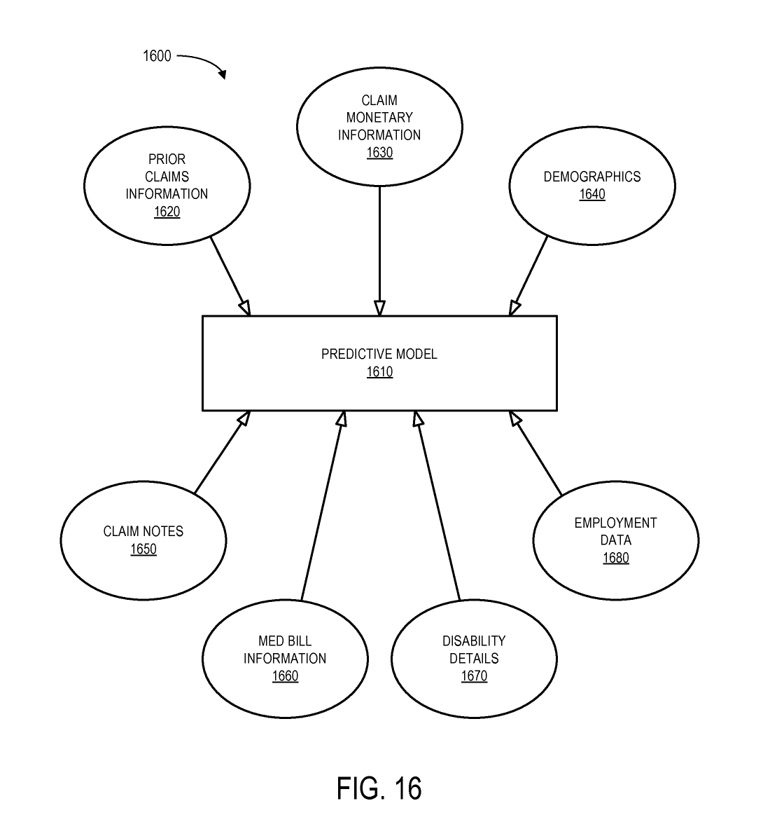

Note that many different types of data might be used to create, evaluate, and/or use a predictive model. For example, FIG. 16 is a block diagram of a system 1600 illustrating inputs to a predictive model 1610 according to some embodiments. In this example, the predictive model 1610 might receive information about prior insurance claims 1620 (e.g., historical data). Moreover, the predictive model 1610 might receive monetary information about claims 1630 (e.g., a total amount of payments made in connection with a claim) and/or demographic information 1640 (e.g., the age or sex of a claimant). According to some embodiments, claim notes 1650 are input to the predictive model 1610 (e.g., and keywords may be extracted from the notes 1650). Other types of information that might be provided to the predictive model 1610 include medical bill information 1660 (e.g., including information about medical care that was provided to a claimant), disability details 1670 (e.g., which part or parts of the body have been injured), employment data 1680 (e.g., an employee's salary or how long an employee has worked for an employer), and prior SIU team determinations.

The predictive model 1610, in various implementation, may include one or more of neural networks, Bayesian networks (such as Hidden Markov models), expert systems, decision trees, collections of decision trees, support vector machines, or other systems known in the art for addressing problems with large numbers of variables. Preferably, the predictive model(s) are trained on prior data and outcomes known to the insurance company. The specific data and outcomes analyzed vary depending on the desired functionality of the particular predictive model 1610. The particular data parameters selected for analysis in the training process are determined by using regression analysis and/or other statistical techniques known in the art for identifying relevant variables in multivariable systems. The parameters can be selected from any of the structured data parameters stored in the present system, whether the parameters were input into the system originally in a structured format or whether they were extracted from previously unstructured text.

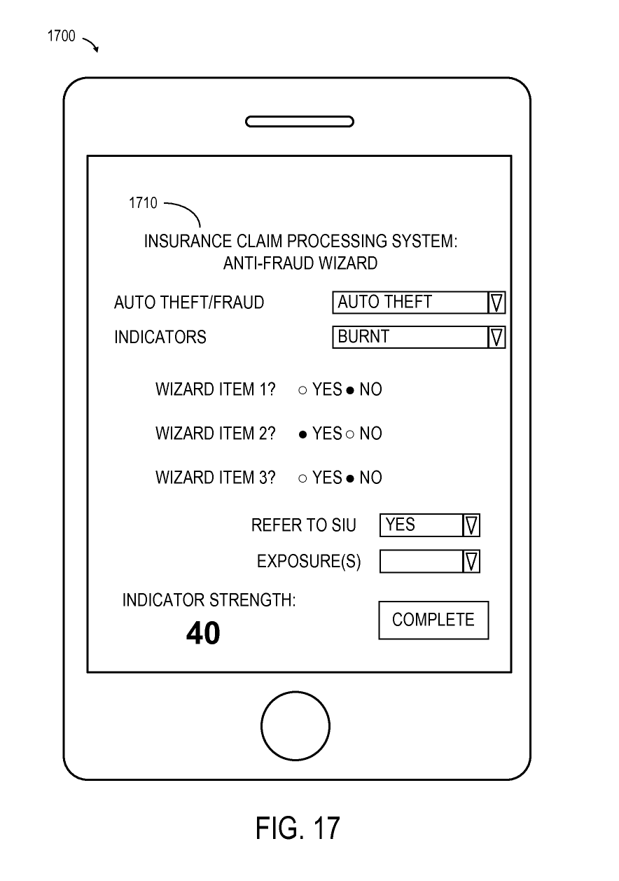

Applicants have discovered that embodiments described herein may be particularly useful in connection with the insurance policies described herein. Note, however, that other types of insurance may also be associated with embodiments described herein. Moreover, the displays 500, 1000, 1200 illustrated with respect to FIGS. 5, 10, and 12 are only provided as examples, and embodiments may be associated with any other types of user interfaces. For example, FIG. 17 illustrates a handheld insurance fraud detection display 1700 according to some embodiments. In this particular user display 1700, an anti-fraud wizard 1710 may be completed by a claim handler.

Note that the present invention provides significant technical improvements to insurance claim fraud detection and/or assignments to special investigation unit platforms. The present invention is directed to more than merely a computer implementation of a routine or conventional activity previously known in the industry as it significantly advances the technical efficiency, access and/or accuracy of insurance claim fraud detection by implementing a specific new method and system as defined herein. The present invention is a specific advancement in the area of insurance claim fraud detection by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance, client and/or vendor systems, networks and subsystems. For example, in the present invention tens of thousands insurance claims may be analyzed and automatically assigned to a claim handler and/or a special investigation unit platform as appropriate.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system having a data sharing architecture for a network of computers to perform insurance fraud detection, comprising:
a communication device to receive data indicative of a plurality of insurance claims submitted in connection with insurance policies;
a computer storage unit for receiving, storing, and providing said data indicative of the plurality of insurance claims; and
a fraud detection platform processor in communication with the storage unit, wherein the processor is configured for:
automatically determining that a first insurance claim is associated with a first type of insurance and that a second insurance claim is associated with a second type of insurance different from the first type of insurance,
analyzing the received data associated with the first insurance claim, in accordance with first fraud detection logic, to calculate an indicator strength score for the first insurance claim,
based on the indicator strength score for the first insurance claim, determining a first questionable loss status appropriate for the first insurance claim, wherein the first questionable loss status comprises one of: (i) an unlikely questionable loss that is not automatically referred to a special investigation unit platform, (ii) a likely questionable loss that is automatically referred to the special investigation unit platform, and (iii) a potential questionable loss that is flagged for further review by a claim handler,
analyzing the received data associated with the second insurance claim, in accordance with second fraud detection logic different from the first fraud detection logic, to determine a second questionable loss status appropriate for the second insurance claim, and
transmitting indications of the first and second questionable loss statuses.

2. The system of claim 1, wherein the processor is further for:
receiving updated information about the first insurance claim,
analyzing the updated data associated with the first insurance claim, in accordance with first fraud detection logic, to calculate an updated indicator strength score for the first insurance claim,
based on the updated indicator strength score for the first insurance claim, determining an updated questionable loss status appropriate for the first insurance claim.

3. The system of claim 1, wherein analyzing the received data associated with the first insurance claim, in accordance with the first fraud detection logic, is further associated with a fraud detection wizard completed by a claim handler.

4. The system of claim 3, wherein the processor is further configured for:
displaying the indicator strength score to the claim handler via a graphical user interface display.

5. The system of claim 4, wherein said calculating comprises summing a series of indicators relevant to the first insurance claim, each relevant indicator being multiplied by an indicator weight.

6. The system of claim 1, wherein the processor is further configured for:
automatically generating claim notes to be forwarded to a special investigation unit platform.

7. The system of claim 1, wherein the processor is further configured for:
displaying, to a claim handler, an investigation checklist including a plurality of investigation tasks, and
receiving, from the claim handler, a status for each investigation task, wherein at least one status comprises an inquiry to a special investigation unit platform.

8. The system of claim 1, wherein at least one of the first and second types of insurance are associated with at least one of: (i) workers' compensation insurance, (ii) automobile insurance, (iii) homeowners insurance, (iv) property insurance, (v) general liability insurance, (vi) commercial insurance, and (vii) personal insurance.

9. The system of claim 1, wherein at least one of the first and second fraud detection logic is associated with at least one of: (i) an indication an insured reported claim as questionable, (ii) an insurance period start date, (iii) an insurance period end date, (iv) an employment start date, and (v) an employment end date, (vi) prior insurance claims, (vii) disciplinary action information, (viii) a lack of a witness, (ix) claimant attorney information, and (x) a medical bill date.

10. The system of claim 1, wherein at least one of the first and second fraud detection logic is associated with at least one of: (i) vehicle damage information, (ii) a vehicle repair location, (iii) an arson indication, (iv) an accident type, and (v) a time of accident.

11. The system of claim 1, wherein the received data indicative of a plurality of insurance claims are associated with first notices of loss.

12. The system of claim 1, wherein the received data indicative of a plurality of insurance claims include at least three of: (i) a date and time, (ii) a claim number, (iii) a claim type, (iv) a loss date, (v) a benefit state, (vi) a claimant name, (vii) a claimant date of birth, (viii) a cause of injury, (ix) a claim description, (x) a body part, (xi) an injury, (xii) a return to work date, (xiii) an indication of whether the claimant was injured doing normal job duties, (xiv) an employment status, (xv) an indication of whether an injury resulted in death, (xvi) an indication of whether the injury requires surgery, (xvii) an indication of whether claim involves equipment or machinery, (xviii) an indication of whether safety equipment was provided, (xix) an indication of whether the claim is questionable, and (xx) an indication of whether and injured worker is represented by an attorney.

13. The system of claim 1, wherein the processor is further configured for:
automatically transmitting indications of the first and second questionable loss status to at least one of: (i) an email server, (ii) a workflow application, (iii) a report generator, (iv) a calendar application, (v) a claim handler system, and (v) a special investigation unit platform.

14. The system of claim 1, wherein the data indicative of the plurality of insurance claims is received via at least one of: (i) submitted paper claims, (ii) telephone call center operators, and (iii) an online claim submission web site.

15. The system of claim 1, wherein at least one of the first and second fraud detection logic is associated with a predictive model trained with historical insurance claim information.

16. The system of claim 15, wherein the predictive model is associated with at least one of: (i) a neural network, (ii) a Bayesian network, (iii) a Hidden Markov model, (iv) an expert system, (v) a decision tree, (vii) a collection of decision trees, (viii) a support vector machine, and (ix) weighted factors.

17. A method to administer a data sharing architecture for a network of computers to perform insurance fraud detection for an insurance claim processing system, comprising:
receiving, by a communication device, data indicative of a plurality of insurance claims submitted in connection with insurance policies;
storing, by a computer storage unit, said data indicative of the plurality of insurance claims;
automatically determining, by a fraud detection platform processor, that a first insurance claim is associated with a first type of insurance and that a second insurance claim is associated with a second type of insurance different from the first type of insurance,
analyzing the received data associated with the first insurance claim, by the fraud detection platform processor in accordance with first fraud detection logic, to calculate an indicator strength score for the insurance claim,
based on the indicator score for the first insurance claim, determining a first questionable loss status appropriate for the first insurance claim, wherein the first questionable loss status comprises one of: (i) an unlikely questionable loss that is not automatically referred to a special investigation unit platform, (ii) a likely questionable loss that is automatically referred to the special investigation unit platform, and (iii) a potential questionable loss that is flagged for further review by a claim handler,
analyzing the received data associated with the second insurance claim, by the fraud detection platform processor in accordance with second fraud detection logic different from the first fraud detection logic, to determine a second questionable loss status appropriate for the second insurance claim; and
transmitting indications of the first and second questionable loss statuses from the fraud detection platform processor.

18. The method of claim 17, wherein further comprising:
receiving updated information about the first insurance claim,
analyzing the updated data associated with the first insurance claim, in accordance with first fraud detection logic, to calculate an updated indicator strength score for the first insurance claim,
based on the updated indicator strength score for the first insurance claim, determining an updated questionable loss status appropriate for the first insurance claim.

19. The method of claim 17, wherein analyzing the received data associated with the first insurance claim, in accordance with the first fraud detection logic, is further associated with a fraud detection wizard completed by a claim handler and the processor is further configured for:
displaying the indicator strength score to the claim handler via a graphical user interface display.

20. The method of claim 17, wherein the processor is further configured for:
automatically generating claim notes to be forwarded to a special investigation unit platform.

21. The method of claim 17, wherein the processor is further configured for:
displaying, to a claim handler, an investigation checklist including a plurality of investigation tasks, and
receiving, from the claim handler, a status for each investigation task, wherein at least one status comprises an inquiry to a special investigation unit platform.

22. A system for insurance fraud detection, comprising:
a communication device to receive data indicative of a plurality of insurance claims submitted in connection with insurance policies;
a computer storage unit for receiving, storing, and providing said data indicative of the plurality of insurance claims; and
a fraud detection platform processor in communication with the storage unit, wherein the processor is configured for:
automatically determining that a first insurance claim is associated with a first type of insurance and that a second insurance claim is associated with a second type of insurance different from the first type of insurance,
analyzing the received data associated with the first insurance claim, in accordance with first fraud detection logic, to determine a first questionable loss status appropriate for the first insurance claim,
analyzing the received data associated with the second insurance claim, in accordance with second fraud detection logic different from the first fraud detection logic, to determine a second questionable loss status appropriate for the second insurance claim, and
transmitting indications of the first and second questionable loss statuses, wherein the first questionable loss status comprises one of: (i) an unlikely questionable loss that is not automatically transmitted to a special investigation unit platform, (ii) a likely questionable loss that is automatically transmitted to the special investigation unit platform, and (iii) a potential questionable loss that is flagged for further review by a claim handler.

23. The system of claim 22, wherein analyzing the received data associated with the first insurance claim, in accordance with the first fraud detection logic, is further associated with a fraud detection wizard completed by a claim handler.

24. The system of claim 23, wherein the processor is further configured for:
calculating an indicator strength score for the first insurance claim by summing a series of indicators relevant to the first insurance claim, each relevant indicator being multiplied by an indicator weight, and
displaying the indicator strength score to the claim handler via a graphical user interface display.

25. The system of claim 24, wherein at least one of the first and second types of insurance are associated with at least one of: (i) workers' compensation insurance, (ii) automobile insurance, (iii) homeowners insurance, (iv) property insurance, (v) general liability insurance, (vi) commercial insurance, and (vii) personal insurance.
